(19) United States
(12) Patent Application Publication
(10) Pub. No.: US 2010/0003859 A1
(43) Pub. Date: Jan. 7, 2010

(54) COMPOSITE CONNECTOR

(76) Inventor: Yi-Fang CHUANG, Sanchong City (TW)

Correspondence Address: HDLS Patent & Trademark Services, P.O. BOX 220746, CHANTILLY, VA, 20153-0746, US

(21) Appl. No.: 12/418,759

(22) Filed: Apr. 6, 2009

(30) Foreign Application Priority Data
Jul. 4, 2008 (TW) 097211927

(51) Int. Cl. H01R 33/00

(52) U.S. Cl. 439/653

(57) ABSTRACT

A composite connector includes a base, a DisplayPort and an eSATA electrical connector. The base is provided with a first assembling hole and a second assembling hole. The DisplayPort is assembled in the first assembling hole and has a body. The front end of the body has an insertion opening. The bottom of the body has a plurality of conductive pins. The conductive pins extend to the outside of the base. The eSATA electrical connector is assembled in the second assembling hole and has a body. The front end of the body has an insertion hole. The bottom of the body has a plurality of conductive pins. The conductive pins extend to the outside of the base. Via the Displayport and the eSATA electrical connector, a transmission line for a displayer and an eSATA transmission line can be connected thereto.

### BACKGROUND OF THE INVENTION

1. Field of the Invention

The present invention relates to a connector, and in particular to a composite connector having a DisplayPort and an eSATA electrical connector.

2. Description of Prior Art

With the continuous advancement of science and technology, many peripheral devices for a computer are manufactured sequentially. In order to electrically connect the computer to these new-generation peripheral devices, various connecting ports of different standards are mounted on the main board of the computer, so that the computer can be electrically connected to the peripheral devices via transmission lines. In this way, the computer can control the outputted signals or transmit data to the peripheral devices. Alternatively, the peripheral devices can transmit the data back to the computer.

Recently, since the current electronic devices are designed to be more and more compact, and the volume of the computer available in the market is also made compact, the volume of the main board within the computer has to be reduced accordingly. Under the circumstances of reduced volume of the main board and the limited space of the main board, it is an important issue to mount connecting ports of different standards on the main board.

For example, a new monitor technology standard is proposed, whereby a personal computer, television or projector having better definition and fewer connecting lines can be provided for the consumers. Such s standard is referred to as “DisplayPort”, in which audio signals and video signals share the same cable, so that totally four channels are used for transmission. Thus, the data transmission speed is at most up to 10.8 Gb/s, so that the number of necessary channels is less than that of the current cable interface. Moreover, the ports (electrical connectors) of an external storage device (such as a mobile hard disk) still adopt popular USB2.0 or IEEE1394. Although the data transmission speed of these two kinds of ports is up to 480 Mbps/400 Mbps, they cannot bring the hard disk to exhibit its maximum transmission speed. Thus, the eSATA port is proposed. The eSATA is an abbreviation of External Serial ATA, which is an external extension standard of a SATA port. The transmission speed of eSATA is identical to that of SATA. In other words, the eSATA is an “external” SATA, which is used to connect external devices but not internal SATA devices. For example, if an eSATA port is provided, it is easy to connect the SATA hard disk to the eSATA port of the main board without opening the casing of the computer and replacing the SATA hard disk. Most of the main boards of desk-top computers have been already provided with eSATA ports.

If the DisplayPort and the eSATA electrical connector are to be mounted on the main board 100 shown in FIG. 1, the Displayport and the eSATA electrical connector have to be electrically connected to the main board 100 one by one. Otherwise, due to the limited space of the main board 100, one or ones of the electrical connectors will be inevitably sacrificed. Alternatively, a supporting body 300 is used to overlap the DislayPort or eSATA electrical connector on the other one or two electrical connectors 200, whereby the DisplayPort and the eSATA electrical connector can be mounted on the main board 100. However, such a process may make it more difficult to manufacture the main board 100.

### SUMMARY OF THE INVENTION

The present invention is to integrate the DisplayPort and the eSATA electrical connector together to form a composite connector. Such a composite connector can be electrically connected to the main board easily, thereby reducing the difficulty in manufacturing the main board.

The present invention is to provide a composite connector, which includes: a base, a DisplayPort and an eSATA electrical connector. The base is provided with a first assembling hole and a second assembling hole. A partition is provided between the first assembling hole and the second assembling hole. The partition is provided with a plurality of grooves. The underside of the second assembling hole is provided with a bottom plate. The bottom plate has a plurality of channels. The DisplayPort is assembled in the first assembling hole and has a body. The front end of the body has an insertion opening. The bottom of the body has a plurality of conductive pins. The conductive pins extend from the interior of the body to its exterior and are arranged in the groove. The eSATA electrical connector is assembled in the second assembling hole and has a body. The front end of the body has an insertion hole. The bottom of the body has a plurality of conductive pins. The conductive pins extend from the interior of the body to its exterior and are arranged in the plurality of channels of the bottom plate.

### BRIEF DESCRIPTION OF THE DRAWINGS

FIG. 1 is a schematic view showing a conventional main board being electrically connected with electrical connectors of different standards;

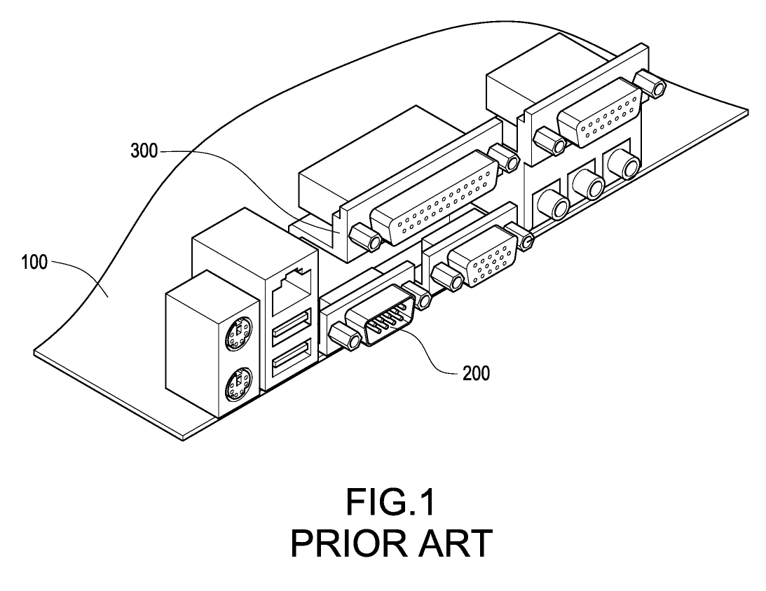

FIG. 2 is an exploded perspective view showing the composite connector of the present invention;

FIG. 3 is an assembled perspective view showing the composite connector of the present invention;

FIG. 4 is an assembled perspective view showing the composite connector of the present invention from another viewing angle;

FIG. 5 is a side cross-sectional view showing the composite connector of the present invention;

FIG. 6 is a schematic view showing the operating state of the composite connector of the present invention; and

FIG. 7 is a schematic view showing another composite connector of the present invention.

### DETAILED DESCRIPTION OF THE INVENTION

The characteristics and technical contents of the present invention will be explained with reference to the accompanying drawings. However, the drawings are illustrative only but not used to limit the present invention.

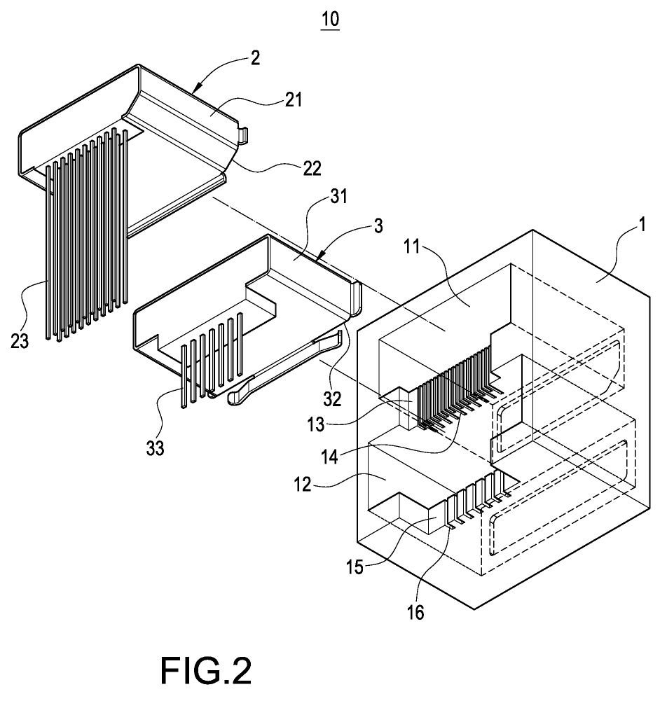

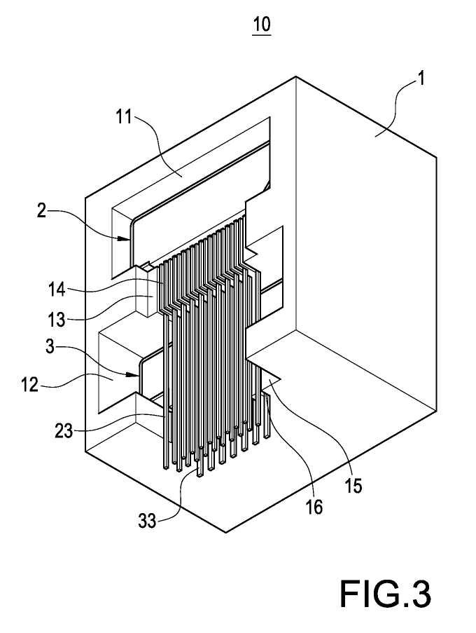

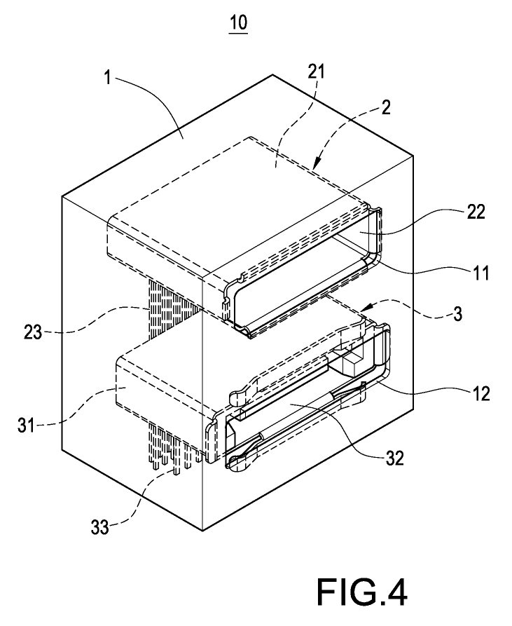

Please refer to FIGS. 2, 3 and 4. FIG. 2 is an exploded perspective view showing the composite connector of the present invention, FIG. 3 is an assembled perspective view showing the composite connector of the present invention, and FIG. 4 is an assembled perspective view showing the composite connector of the present invention from another viewing angle. The present invention provides a composite connector 10, which includes a base 1, a DisplayPort 2 and an eSATA electrical connector 3.

The base 1 is made of an insulating material and has a first assembling hole 11 and a second assembling hole 12 that both penetrate the base 1. The first assembling hole 11 allows the DisplayPort 2 to be assembled therein, and the second assembling hole 12 allows the eSATA electrical connector 3 to be assembled therein. A partition 13 is provided between the first assembling hole 11 and the second assembling hole 12. The partition 13 is provided thereon with a plurality of grooves 14. The grooves 14 allow conductive pins 23 of the DisplayPort 2 to pass through and extend outside the underside of the base 1. Furthermore, the underside of the second assembling hole 12 is provided with a bottom plate 15. The bottom plate 15 has a plurality of channels 16. The channels 16 allow conductive pins 31 of the eSATA electrical connector 3 to pass through and extend outside the base 1.

The DisplayPort 2 belongs to prior art, and it is assembled in the first assembling hole 11. The DisplayPort 2 has a body 21. The front end of the body 21 has an insertion opening 22. The insertion opening 22 allows the plug of a transmission line (not shown) for a displayer to be inserted therein. The bottom of the body 21 has the plurality of conductive pins 23. The conductive pins 23 extend from the interior of the body 21 to its outside. The conductive pins 23 are arranged in the grooves 14.

The eSATA electrical connector 3 belongs to prior art, and it is assembled in the second assembling hole 12. The eSATA electrical connector 3 has a body 31. The front end of the body 31 has an insertion hole 32. The insertion hole 32 allows the plug of an eSATA transmission line (not shown) to be inserted therein. The bottom of the body 31 has a plurality of conductive pins 33. The conductive pins 33 extend from the interior of the body 31 to its exterior. The conductive pins 33 are arranged in the plurality of channels 16 of the bottom plate 15.

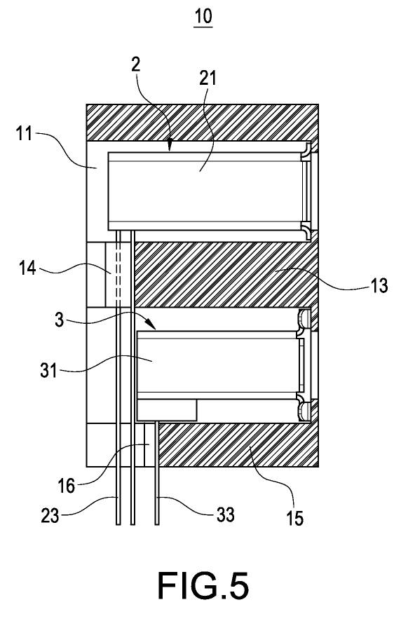

Please refer to FIG. 5, which is a side cross-sectional view of the composite connector of the present invention. As shown in the figure, when the DisplayPort 2 is mounted in the first assembling hole 11 of the base 1, the conductive pins 23 of the body 21 pass through the grooves 14 of the partition 13 and extend to the outside of the base 1. When the body 31 of the eSATA electrical connector 3 is mounted in the second assembling hole 12, the conductive pins 33 of the body 31 also pass through the channels 16 of the bottom plate 15 and extend to the outside of the base 1. When the conductive pins 23 of the DisplayPort 2 and the conductive pins 33 of the eSATA electrical connector 3 extend to the outside of the base 1, the conductive pins 23 and 33 can be electrically connected to the main board (not shown) of an electronic device, thereby fixing the composite connector 10 to the main board.

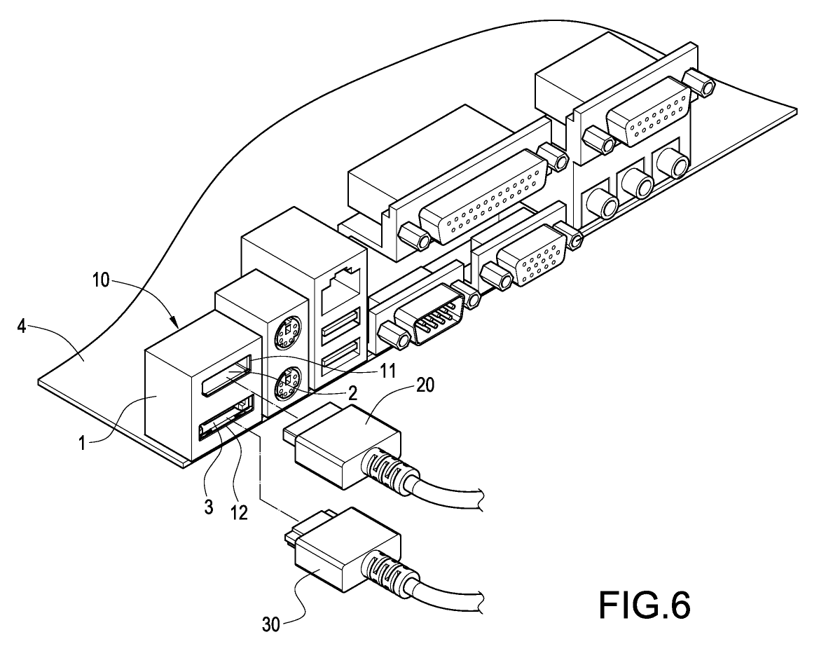

Please refer to FIG. 6, which is a schematic view showing the operating state of the composite connector of the present invention. As shown in this figure, after the composite connector 10 is electrically connected to the main board 4 of the electronic device, the composite connector 10 can be fixed to the main board 4. When a user has to transmit audio/video signals, an external displayer (not shown) is electrically connected to the DisplayPort 2 via a displayer transmission line 20. The image signals on the main board 4 can be transmitted to the displayer.

When the data in the electronic device is reproduced for backup or data is downloaded, an external mobile hard disk (not shown) can be electrically connected to the eSATA electrical connector 3 via an eSATA transmission line 30, so that the data in the electronic device can be transmitted to the external mobile hard disk.

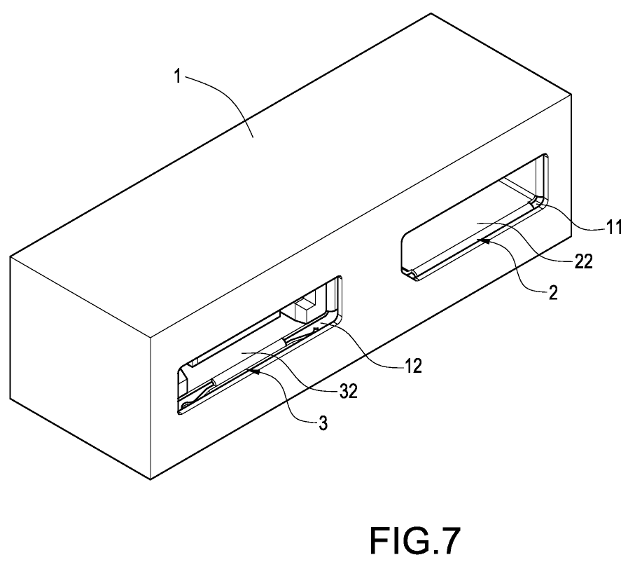

Please refer to FIG. 7, which is a schematic view showing another composite connector of the present invention. As shown in this figure, in addition to overlap the DislayPort 2 and the eSATA electrical connector 3 on the base 1, the DisplayPort 2 and the eSATA electrical connector 3 can be juxtaposed in the base 1. The user can choose the overlapped or juxtaposed arrangement according to practical demands.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A composite connector, comprising:
a base having a first assembling hole and a second assembling hole;
a DisplayPort assembled in the assembling hole; and
an eSATA electrical connector assembled in the second assembling hole.

2. The composite connector according to claim 1, wherein the base is made of an insulating material.

3. The composite connector according to claim 1, wherein a partition is provided between the first assembling hole and the second assembling hole, the partition is provided with a plurality of grooves.

4. The composite connector according to claim 1, wherein the second assembling hole has a bottom plate, the bottom plate is provided with a plurality of channels.

5. The composite connector according to claim 1, wherein DisplayPort has a body, the front end of the body has an insertion opening, the bottom of the body has a plurality of conductive pins, the conductive pins extend from the interior of the body to its exterior and are arranged in the plurality of grooves of the partition.

6. The composite connector according to claim 1, wherein the eSATA electrical connector has a body, the front end of the body has an insertion hole, the bottom of the body has a plurality of conductive pins, the conductive pins extend from the interior of the body to its exterior and are arranged in the plurality of grooves of the bottom plate.
